(19) United States
(12) Patent Application Publication
(10) Pub. No.: US 2025/0133975 A1
(43) Pub. Date: May 1, 2025

(54) MOUNTING ASSEMBLY FOR AN AGRICULTURAL IMPLEMENT

(71) Applicant: CNH Industrial America LLC, New Holland, PA (US)

(72) Inventor: Michael G. Kovach, Morton, IL (US)

(21) Appl. No.: 18/494,908

(22) Filed: Oct. 26, 2023

(51) Int. Cl. A01B 35/28; A01B 15/16

(52) U.S. Cl. CPC A01B 35/28; A01B 15/16

(57) ABSTRACT

A mounting assembly for an agricultural implement can include a clamp having a first wall, a second wall, and a support flange. The support flange can be positioned on an opposing side of the first wall from the second wall. A support plate can define a first through-hole and a second through-hole. A first fastener and a second fastener can each include a first leg with a first end portion and a second leg with a second end portion. The first end portion of each of the first fastener and the second fastener can be coupled to the clamp and the second leg of each of the first fastener and the second fastener can be positioned respectively through the first through-hole and a second through-hole. A ground-engaging tool hanger can be positioned between the support plate and the second wall. A scraper assembly can be operably coupled with the support flange.

### FIELD OF THE INVENTION

The present subject matter relates generally to tillage implements that may be operated within an agricultural field.

### BACKGROUND OF THE INVENTION

In some cases, to increase agricultural performance from a field, a farmer may cultivate the soil, typically through a tillage operation. For instance, tillage operations may be performed by pulling a tillage implement behind an agricultural work vehicle, such as a tractor. Tillage implements can include one or more ground-engaging tools configured to engage the soil as the implement is moved across the field. For example, a cultivator/harrow is capable of simultaneously tilling the soil and leveling the tilled soil in preparation for planting. In some cases, the cultivator/harrow can include a gang of disk blades that can be operably coupled with the frame of the implement through top and bottom plates or castings with long bolts to secure the disk blades to the frame. During tillage operations, however, the long bolts can stretch and loosen in the field. Moreover, the plates can flex or bend. Eventually, the disk blades can become loose and move on the frame, or the hardware can fatigue and fail.

Accordingly, an improved mounting assembly for connecting a frame tube to a ground-engaging tool hanger such that the mounting assembly withstands rigorous application would be welcomed in the technology.

### BRIEF DESCRIPTION OF THE INVENTION

Aspects and advantages of the technology will be set forth in part in the following description, or may be obvious from the description, or may be learned through practice of the technology.

In some aspects, the present subject matter is directed to a mounting assembly for an agricultural implement that includes a clamp including a first wall, a second wall, and a support flange. The support flange is positioned on an opposing side of the first wall from the second wall. A support plate defines a first through-hole and a second through-hole. A first fastener and a second fastener each include a first leg with a first end portion and a second leg with a second end portion. The first end portion of each of the first fastener and the second fastener are coupled to the clamp and the second leg of each of the first fastener and the second fastener are positioned respectively through the first through-hole and a second through-hole. A ground-engaging tool hanger is positioned between the support plate and the second wall. A scraper assembly is operably coupled with the support flange.

In some aspects, the present subject matter is directed to a method for attaching a ground-engaging tool hanger to a frame tube of an agricultural tillage implement. The method includes operably coupling the frame tube and the ground-engaging tool hanger together using a clamp, the frame tube positioned on a first side of a first wall of the clamp. The method also includes operably coupling a scraper assembly with a support flange of the clamp, the support flange positioned on a second side of the first wall of the clamp.

In some aspects, the present subject matter is directed to a mounting assembly for an agricultural implement that includes a clamp including a first wall, a second wall, and a support flange. The support flange is positioned on an opposing side of the first wall from the second wall. A ground-engaging tool hanger is operably coupled with the second wall of the clamp. A scraper assembly is operably coupled with the support flange.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a front perspective view of an agricultural vehicle and an agricultural implement in accordance with aspects of the present subject matter;

FIG. 2 illustrates a front perspective view of the agricultural implement in accordance with aspects of the present subject matter;

FIG. 3 illustrates a front perspective view of a mounting assembly configured to operably couple a gang of disk blades to a frame tube of the implement in accordance with aspects of the present subject matter;

FIG. 4 illustrates a top plan view of the mounting assembly in accordance with aspects of the present subject matter

FIG. 5 illustrates a top plan view of the mounting assembly in accordance with aspects of the present subject matter;

FIG. 6 illustrates a top perspective view of a clamp of the mounting assembly in accordance with aspects of the present subject matter; and

FIG. 7 illustrates a flow diagram of a method for attaching a ground-engaging tool hanger to a frame tube of an agricultural tillage implement in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to a mounting assembly for an agricultural implement. The mounting assembly can be configured to operably couple a ground-engaging tool, such as a gang of disk blades, to the implement.

In some cases, the mounting assembly can include a clamp including a first wall, a second wall, and a support flange. The support flange can be positioned on an opposing side of the first wall from the second wall. The mounting assembly can also include a support plate defining a first through-hole and a second through-hole. Moreover, the mounting assembly can include a first fastener and a second fastener. Each of the first fastener and the second fastener can include a first leg with a first end portion and a second leg with a second end portion. The first end portion of each of the first fastener and the second fastener can be coupled to the clamp and the second leg of each of the first fastener and the second fastener positioned respectively through the first through-hole and a second through-hole.

In various examples, a ground-engaging tool hanger can be positioned between the support plate and the second wall. The ground-engaging tool hanger can be configured to operably couple with a ground-engaging tool, such as one or more disk blades, for retaining the ground-engaging tool in a generally consistent position relative to a frame of the implement.

Additionally or alternatively, the support flange may support one or more additional structures. For instance, the support flange may support a scraper assembly. During the operation of the implement, dirt, earth, residue, etc. tend to build up or accumulate among the individual ground-engaging tools, such as disk blades, residue-cutting blades, and/or any other practicable tool. This dirt, earth, residue, etc. may be removed by the scraper assembly to maintain good operation of the gang of the ground-engaging tools.

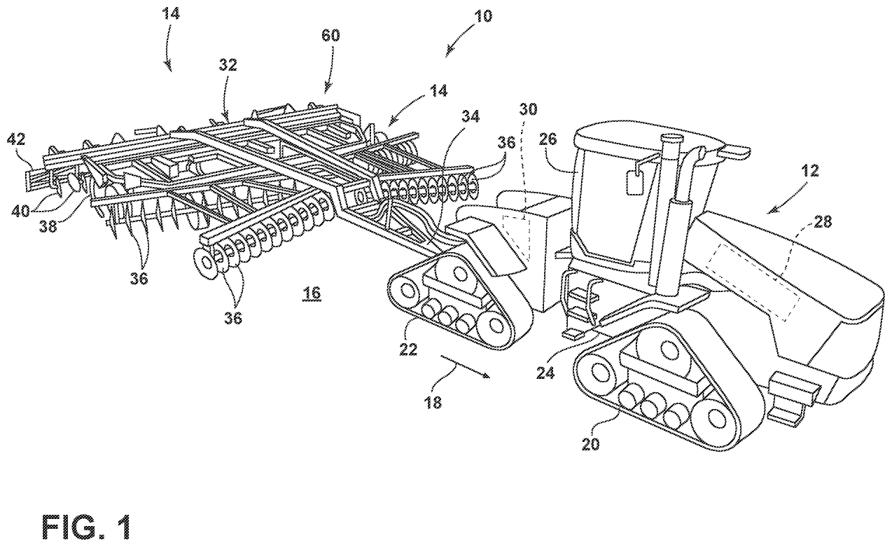

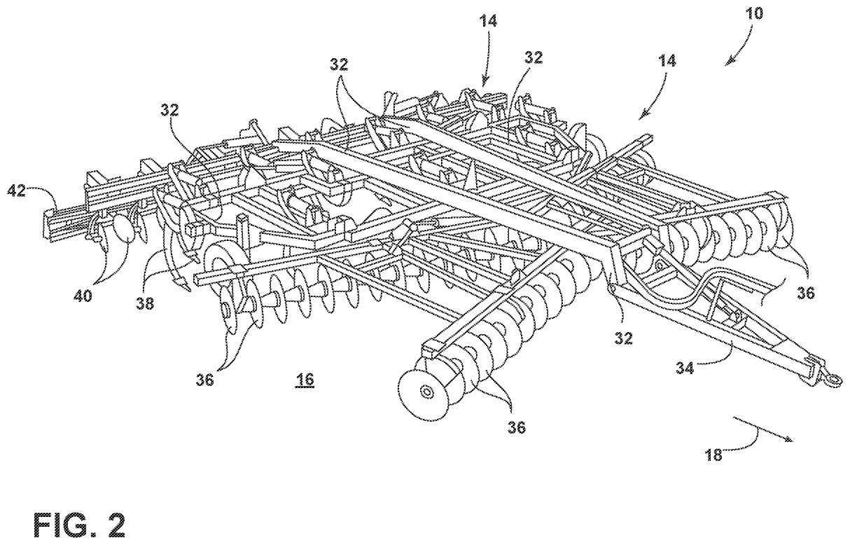

Referring now to drawings, FIGS. 1 and 2 respectively illustrate a front perspective view and a rear perspective view of an agricultural machine 10 in accordance with various aspects of the present subject matter. As shown, the agricultural machine 10 can include a work vehicle 12 and an associated agricultural implement 14. In general, the work vehicle 12 can be configured to tow the implement 14 across a field 16 in a direction of travel (e.g., as indicated by arrow 18 in FIG. 1). In the illustrated examples, the work vehicle 12 can be configured as an agricultural tractor and the implement 14 can be configured as an associated tillage implement. However, in other embodiments, the work vehicle 12 may be configured as any other suitable type of vehicle, such as an agricultural harvester, a self-propelled sprayer, and/or the like. Similarly, the implement 14 may be configured as any other suitable type of implement, such as a planter. Furthermore, the agricultural machine 10 may correspond to any suitable powered and/or unpowered agricultural machine 10 (including suitable vehicles and/or equipment, such as only a work vehicle or only an implement). Additionally, the agricultural machine 10 may include two or more associated vehicles, implements, and/or the like (e.g., a tractor, a planter, and an associated air cart).

As shown in FIGS. 1 and 2, the work vehicle 12 includes a pair of front track assemblies 20, a pair of rear track assemblies 22, and a frame or chassis 24 coupled to and supported by the track assemblies 20, 22. An operator's cab 26 may be supported by a portion of the chassis 24 and may house various input devices for permitting an operator to control the operation of one or more components of the work vehicle 12 and/or one or more components of the implement 14. Additionally, the work vehicle 12 may include a power plant 28 and a transmission 30 mounted on the chassis 24. The transmission 30 may be operably coupled to the power plant 28 and may provide variably adjusted gear ratios for transferring power to the track assemblies 20, 22 via a drive axle assembly (or via axles if multiple drive axles are employed).

Additionally, as shown in FIGS. 1 and 2, the implement 14 may generally include a carriage frame assembly 32 configured to be towed by the work vehicle 12 via a pull hitch or tow bar 34 in the direction of travel 18 of the vehicle 12. The carriage frame assembly 32 may be configured to support a plurality of ground-engaging tools, such as a plurality of disk blades 36, shanks 38, levelers 40 (e.g., leveling blades), basket assemblies 42, tines, spikes, and/or the like. In several embodiments, the various ground-engaging tools may be configured to perform a tillage operation or any other suitable ground-engaging operation across the field 16 along which the implement 14 is being towed. It should be understood that, in addition to being towed by the work vehicle 12, the implement 14 may also be a semi-mounted implement connected to the work vehicle 12 via a two-point hitch or the implement 14 may be a fully mounted implement (e.g., mounted the work vehicle's three-point hitch).

It will be appreciated that the configuration of the agricultural machine 10 described above and shown in FIGS. 1 and 2 is provided only to place the present subject matter in an example field of use. Thus, it will be appreciated that the present subject matter may be readily adaptable to any manner of machine configuration, including any suitable work vehicle configuration and/or implement configuration. For example, in an alternative embodiment of the work vehicle 12, a separate frame or chassis may be provided to which the engine, transmission, and drive axle assembly are coupled, a configuration common in smaller tractors. Still other configurations may use an articulated chassis to steer the work vehicle 12 or rely on tires/wheels in lieu of the track assemblies 20, 22. Similarly, as indicated above, the carriage frame assembly 32 of the implement 14 may be configured to support any other suitable combination of type of ground-engaging tools.

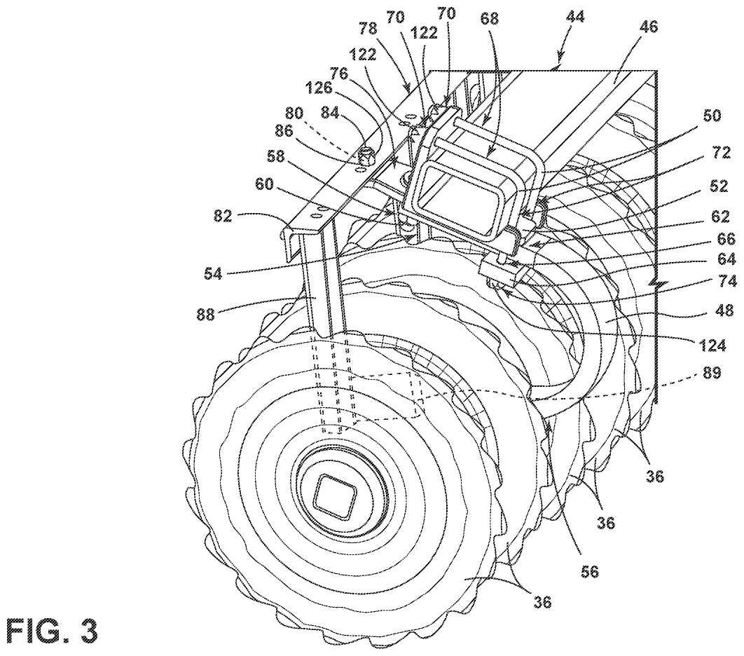

Referring now to FIG. 3, one or more disk blades 36 may be operably coupled with a mounting assembly 44. The mounting assembly 44 may further be operably coupled with a frame tube 46 of the implement 14. As illustrated, the frame tube 46 may be part of agricultural tillage implement 14 and can extend generally transverse to the direction of travel 18 (FIG. 1) of the agricultural tillage implement 14 across the field 16. The frame tube 46 can have, for example, a square or rectangular cross-section.

In various examples, the mounting assembly 44 can include a ground-engaging tool hanger 48, at least one fastener 50 (which may be nonlinear, e.g., a bolt defining an L-shape), and/or a clamp 52 (which may be nonplanar, such as a clamp defining an L-shape, a T-shape, and/or any other shape).

The ground-engaging tool hanger 48 can define a proximal end portion 54 and a distal end portion 56. The proximal end portion 54 of the ground-engaging tool hanger 48 can be operably coupled with the clamp 52. For example, a first section 58 of the proximal end portion 54 may be operably coupled with the clamp 52 through the use of one or more hanger fasteners 60. Additionally, or alternatively, a second section 62 of the proximal end portion 54 may be positioned between the clamp 52 and a support plate 64. The support plate 64 can define one or more through-holes 66. In some cases, the one or more fasteners 50 may be positioned through the through-holes 66 defined by the support plate 64. For instance, a first fastener 50 may be positioned on a first lateral side of the ground-engaging tool hanger 48 and through a first through-hole 66 while a second fastener 50 may be positioned on a second opposing lateral side of the ground-engaging tool hanger 48 and through a second through-hole 66. The distal end portion 56 of the ground-engaging tool hanger 48 can be attached to at least one ground-engaging tool 36 which travels (such as by rotating) across the ground and tills the soil of the field 16.

In some examples, the one or more fasteners 50 can be non-linear. For instance, the one or more fasteners 50 may be L-shaped. Moreover, each mounting assembly 44 can include two fasteners 50 (in this way, the one or more fasteners 50 can include two L-shaped fasteners 50). Each fastener 50 can be operably coupled with to the clamp 52, which, in turn, attaches the clamp 52 to frame tube 46. In various examples, each fastener 50 can include a first leg 68 with a first end portion 70 and a second leg 72 with a second end portion 74.

With reference to FIGS. 3-5, in some instances, the clamp 52 can include a support flange 76 extending therefrom. The support flange 76 may be integrally formed or later attached to the clamp 52. As shown, the support flange 76 may support one or more additional structures. For instance, the support flange 76 may support a scraper assembly 78. During the operation of the implement 14, dirt, earth, residue, etc. tend to build up or accumulate between the individual disk blades 36 (and/or any other ground-engaging tool). This dirt, earth, residue, etc. may be removed by the scraper assembly 78 to maintain the favorable operation of the gang of disk blades 36 (and/or any other ground-engaging tool).

In some cases, the support flange 76 can define a void 80. A mounting bracket 82 of the scraper assembly 78 may be operably coupled with the support flange 76 through the insertion of a mounting fastener 84 through the void 80 of the support flange 76 and a respective hole 86 through the mounting bracket 82. The scraper assembly 78 can further include one or more arm members 88, various fasteners, and one or more scraper blades 89 coupled with each of the one or more arm members 88 through the various fasteners. In various examples, the scraper blades 89 are generally mounted at an angle to effect a scraping action on the concave sides or surfaces of the disk blades 36. The location of the scraper blade 89 relative to the respective disk blade 36 can be altered based on the implement design.

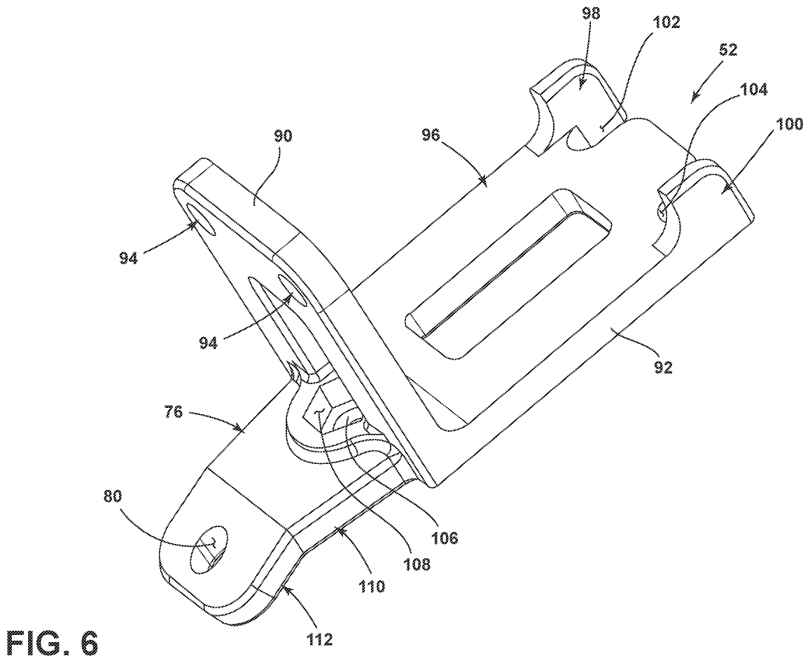

As shown in FIG. 6, the clamp 52 can include a first wall 90 and a second wall 92 which may be generally perpendicular to the first wall 90. As provided herein, the clamp 52 can further include a support flange 76 that is positioned on an opposing side of the first wall 90 from the second wall 92. The clamp 52 can be made of a metallic material, for example, and can be made by a casting operation. In this way, the clamp 52 can be one monolithic piece.

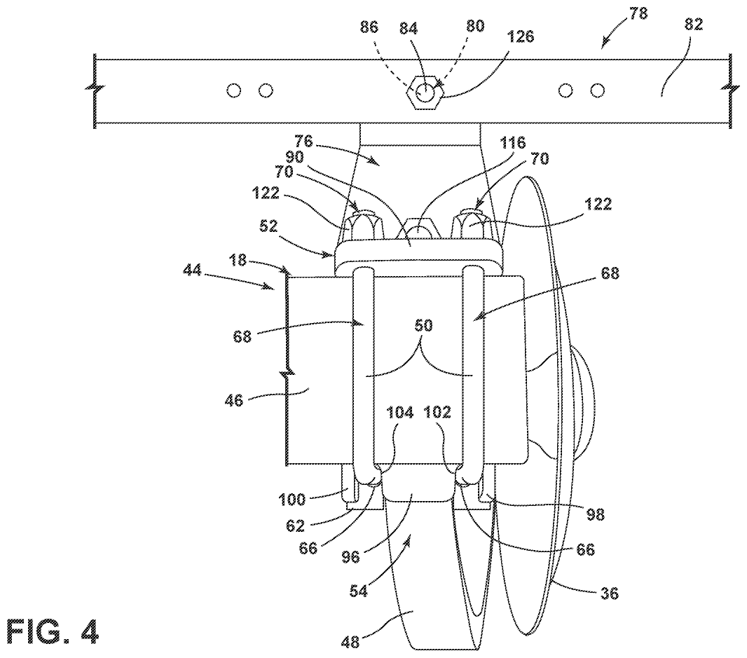

Referring further to FIG. 6, the first wall 90 of the clamp 52 can define first and second through-holes 94, each of which may be configured for receiving therethrough a respective first end portion 70 (FIG. 4) of a first leg 68 (FIG. 4) of a respective fastener 50. The second wall 92 of the clamp 52 includes a body 96, a first upstanding tab 98, and a second upstanding tab 100. The body 96 and the first upstanding tab 98 define a first recess 102, which can be configured for having a second leg 72 (FIG. 6) of a first fastener 50 positioned therein. The body 96 and the second upstanding tab 100 define a second recess 104, which can be configured for having a second leg 72 (FIG. 6) of a second fastener 50 positioned therein. The second wall 92 of the clamp 52 can further define at least a portion of a through-hole 106 in communication with a recess 108.

Still referring to FIG. 6, In some instances, the support flange 76 may be non-parallel to the first wall 90. Additionally or alternatively, the support flange 76 may define a first segment 110 that is offset from the first wall 90 by a first segment offset angle. Additionally, a second segment 112 can extend in an offset direction from the first segment 110 by a second segment offset angle. In some instances, the first segment offset angle and/or the second segment offset angle may be determined based on the structure that is to be attached to the support flange 76. In some examples, a total offset angle, which may be defined by the summation of the first segment offset angle and the second segment offset angle relative to a second wall 92 of the clamp 52, can be less than ninety (90) degrees. Additionally, the total offset angle may be in a positive or negative direction in which the second segment 112 is angled toward the field 16 or away from the field 16. Additionally or alternatively, the first segment offset angle may be less than, equal to, or greater than ninety (90) degrees. Moreover, the support flange 76 defines a void 80 therethrough that can be configured to receive a mounting fastener 84 therethrough.

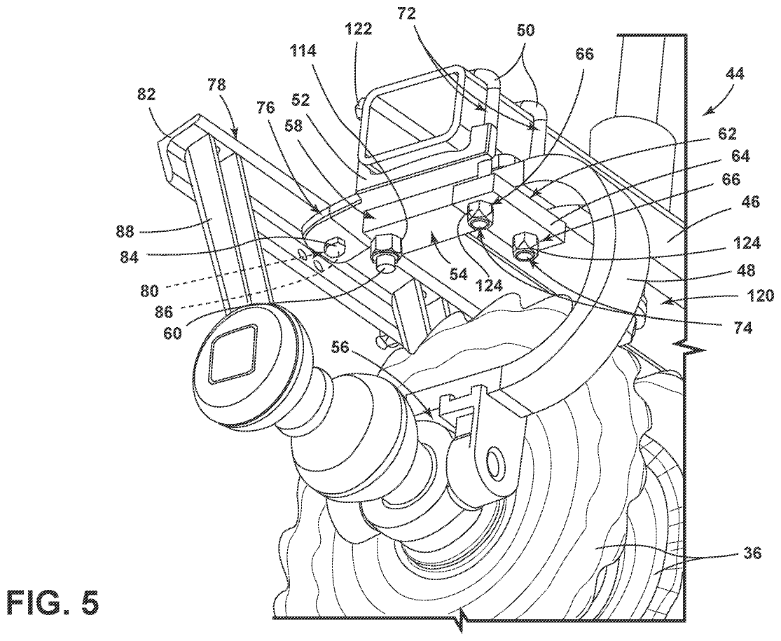

Referring back to FIGS. 3-6, in use, the ground-engaging tool hanger 48 can be mounted to the clamp 52 by way of a hanger fastener 60 being inserted through a corresponding hole 114 defined by the ground-engaging tool hanger 48 and through through-hole 106 defined by the second wall 92 and/or the support flange 76 of the clamp 52. A nut 116 is threadably received on the end portion of the hanger fastener 60 and is thus positioned in the recess 108 after tightening the nut 116 onto the hanger fastener 60 to retain the ground-engaging tool hanger 48 relative to the clamp 52. The frame tube 46 can be positioned along the first wall 90 and the second wall 92 of the clamp 52. In some instances, the first wall 90 of the clamp 52 can be configured to be positioned adjacent to a rear side 118 (FIG. 4) of frame tube 46 and the second wall 92 of the clamp 52 can be configured to be positioned adjacent to a bottom side 120 (FIG. 5) of frame tube 46. In this way, the clamp 52 contacts frame tube 46 on the rear and bottom sides 118, 120 of frame tube 46. In some cases, the first upstanding tab 98 and the second upstanding tab 100 are configured to be positioned on an opposing side of the frame tube 46 from the first wall 90.

In addition, the frame tube 46 and the ground-engaging tool hanger 48 can be operably coupled together using the clamp 52, the fasteners 50, and the support plate 64. For instance, each through-hole 94 of the first wall 90 can receive therethrough a respective first end portion 70 of a respective fastener 50. Thus, a first end portion 70 of one fastener 50 is inserted through one through-hole 94 of the first wall 90 of the clamp 52. A first end portion 70 of the other fastener 50 is inserted through the other through-hole 94 of the first wall 90 of the clamp 52. A nut 122 can be threaded onto the first end portion 70 of each fastener 50 with the first wall 90 positioned adjacent to each nut 122. In this way, the first end portion 70 of each fastener 50 can be connected to the clamp 52. The second leg 72 of the first fastener 50 can be positioned in a first recess 102. The second leg 72 of the second fastener 50 can be positioned in second recess 104. The second leg 72 of first fastener 50 and second leg 72 of second fastener 50 can be configured for having the ground-engaging tool hanger 48 positioned therebetween. Thus, the ground-engaging tool hanger 48 can be positioned between the second leg 72 of the first fastener 50 and the second leg 72 of the second fastener 50.

The support plate 64 can be positioned below ground-engaging tool hanger 48 and can be connected to each fastener 50. That is, the second end portion 74 of each fastener 50 can be operably coupled to the support plate 64 in that second end portion 74 of second leg 72 of each fastener 50 is inserted in a respective through-hole 66 of the support plate 64. A nut 124 can be threaded onto each second end portion 74 to tighten the support plate 64 against the ground-engaging tool hanger 48 and thereby to tighten frame tube 46 onto the clamp 52 and thereby to clamp the frame tube 46 to the ground-engaging tool hanger 48. In this way, the support plate 64 and the clamp 52 retain the ground-engaging tool hanger 48 therebetween.

In addition, a mounting bracket 82 of the scraper assembly 78 may be operably coupled with the support flange 76 through the insertion of a mounting fastener 84 through the void 80 of the support flange 76 and a respective hole 86 through the mounting bracket 82. A nut 126 can be threaded onto the mounting fastener 84 to retain the mounting bracket 82 against the support flange 76. Additionally, one or more fasteners may retain one or more arm members 88 relative to the mounting bracket 82. In turn, one or more scraper blades 89 can be coupled with each of the one or more arm members 88 through the various fasteners.

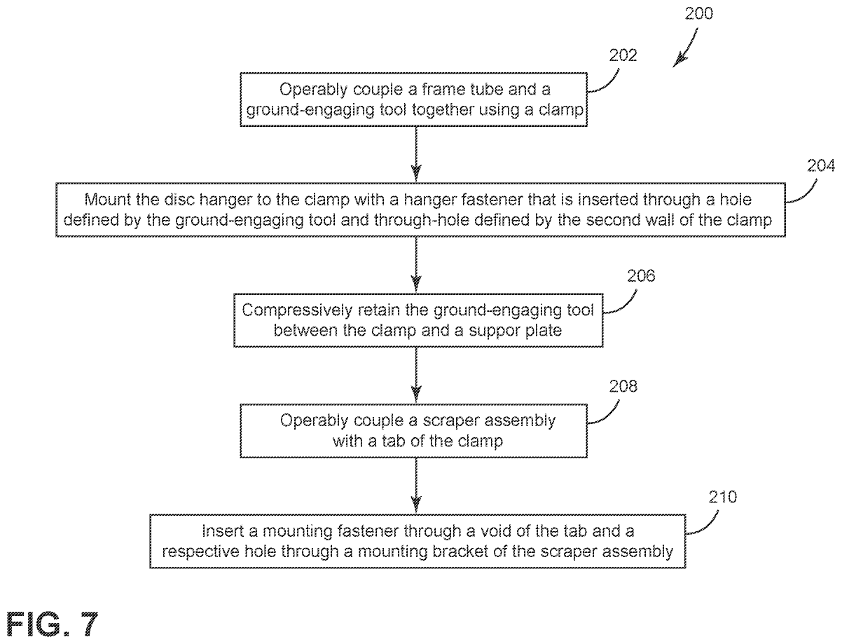

Referring now to FIG. 7, a flow diagram of a method 200 for attaching a ground-engaging tool hanger to a frame tube of an agricultural tillage implement is illustrated in accordance with aspects of the present subject matter. In general, the method 200 will be described herein with reference to the mounting assembly shown in FIGS. 1-6. However, it will be appreciated that the disclosed method 200 may be implemented with agricultural machines having any other suitable machine configurations and/or within systems having any other suitable system configuration. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As illustrated, at (202), the method 200 can include operably coupling a frame tube and a ground-engaging tool hanger together using a clamp. As provided herein, the ground-engaging tool hanger may support one or more disk blades, shanks, levelers (e.g., leveling blades), basket assemblies, tines, spikes, and/or the like. In some cases, the frame tube can be positioned on a first side of a first wall of the clamp. Further, the clamp can define a first upstanding tab and a second upstanding tab. In such instances, the first upstanding tab and the second upstanding tab can be positioned on an opposing side of the frame tube from the first wall.

In some examples, operably coupling the frame tube and the ground-engaging tool hanger together using the clamp can include, at (204), mounting the ground-engaging tool hanger to the clamp with a hanger fastener that is inserted through a hole defined by the ground-engaging tool hanger and a through-hole defined by the second wall of the clamp. Additionally or alternatively, operably coupling the frame tube and the ground-engaging tool hanger together using the clamp can include, at (206), compressively retaining the ground-engaging tool hanger between the clamp and a support plate.

At (208), the method 200 can include operably coupling a scraper assembly with a support flange of the clamp. In some instances, the support flange can be positioned on a second side of the first wall of the clamp. In some examples, operably coupling the scraper assembly with the support flange of the clamp can include, at (210), inserting a mounting fastener through a void of the support flange and a respective hole through a mounting bracket of the scraper assembly.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A mounting assembly for an agricultural implement, the mounting assembly comprising:
a clamp including a first wall, a second wall, and a support flange, the support flange positioned on an opposing side of the first wall from the second wall;
a support plate defining a first through-hole and a second through-hole;
a first fastener and a second fastener, each of the first fastener and the second fastener including a first leg with a first end portion and a second leg with a second end portion, the first end portion of each of the first fastener and the second fastener being coupled to the clamp and the second leg of each of the first fastener and the second fastener positioned respectively through the first through-hole and a second through-hole;
a ground-engaging tool hanger positioned between the support plate and the second wall; and
a scraper assembly operably coupled with the support flange.

2. The mounting assembly of claim 1, wherein the first wall defines a first through-hole and a second through-hole.

3. The mounting assembly of claim 2, wherein the second wall defines a body, a first upstanding tab, and a second upstanding tab, and wherein the body and the first upstanding tab form a first recess and the body and the second upstanding tab form a second recess.

4. The mounting assembly of claim 3, wherein the first end portion of each of the first fastener and the second fastener are coupled to the clamp respectively through the first through-hole and the second through-hole.

5. The mounting assembly of claim 4, wherein the first end portion of each of the first fastener and the second fastener are respectively positioned in one of the first recess and the second recess and through one of the first through-hole and the second through-hole.

6. The mounting assembly of claim 5, wherein the ground-engaging tool hanger is positioned between the second leg of the first fastener and the second leg of the second fastener.

7. The mounting assembly of claim 6, further comprising:
a hanger fastener configured to be inserted through a hole defined by the ground-engaging tool hanger and a through-hole defined by the second wall of the clamp.

8. The mounting assembly of claim 1, wherein the scraper assembly further comprises:
a mounting bracket, the mounting bracket defining a mounting hole through the mounting bracket.

9. The mounting assembly of claim 8, wherein the mounting bracket of the scraper assembly is coupled with the support flange through the insertion of a mounting fastener through a void of the support flange and the mounting hole of the mounting bracket.

10. The mounting assembly of claim 9, wherein the scraper assembly further comprises:
one or more arm members operably coupled with the mounting bracket, wherein one or more scraper blades are operably coupled with each of the one or more arm members.

11. The mounting assembly of claim 1, wherein the support flange defines a first segment that is generally parallel to the first wall and a second segment that extends in an offset direction from the first segment.

12. The mounting assembly of claim 11, wherein an offset angle between the first segment and the second segment is less than ninety (90) degrees.

13. A method for attaching a ground-engaging tool hanger to a frame tube of an agricultural tillage implement, the method comprising:
operably coupling the frame tube and the ground-engaging tool hanger together using a clamp, the frame tube positioned on a first side of a first wall of the clamp; and
operably coupling a scraper assembly with a support flange of the clamp, the support flange positioned on a second side of the first wall of the clamp.

14. The method of claim 13, wherein the clamp defines a first upstanding tab and a second upstanding tab, and wherein the first upstanding tab and the second upstanding tab are positioned on an opposing side of the frame tube from the first wall.

15. The method of claim 13, wherein operably coupling the frame tube and the ground-engaging tool hanger together using the clamp further comprises:
mounting the ground-engaging tool hanger to the clamp with a hanger fastener that is inserted through a hole defined by the ground-engaging tool hanger and a through-hole defined by a second wall of the clamp.

16. The method of claim 15, wherein operably coupling the frame tube and the ground-engaging tool hanger together using the clamp further comprises:
compressively retaining the ground-engaging tool hanger between the clamp and a support plate.

17. The method of claim 16, wherein operably coupling the scraper assembly with the support flange of the clamp further comprises:
inserting a mounting fastener through a void of the support flange and a respective hole through a mounting bracket of the scraper assembly.

18. A mounting assembly for an agricultural implement, the mounting assembly comprising:
a clamp including a first wall, a second wall, and a support flange, the support flange positioned on an opposing side of the first wall from the second wall;
a ground-engaging tool hanger operably coupled with the second wall of the clamp; and
a scraper assembly operably coupled with the support flange.

19. The mounting assembly of claim 18, wherein the support flange defines a first segment that is generally parallel to the first wall and a second segment that extends in an offset direction from the first segment.

20. The mounting assembly of claim 19, wherein an offset angle between the first segment and the second segment is less than ninety (90) degrees.
